(19) United States
(12) Patent Application Publication
(10) Pub. No.: US 2010/0252946 A1
(43) Pub. Date: Oct. 7, 2010

(54) METHOD FOR THE PRODUCTION OF CELLULAR CONCRETE AND FOAMED CONCRETE, AND SYSTEM FOR CARRYING OUT THE METHOD

(75) Inventor: Andreas Stumm, Potsdam (DE)

Correspondence Address: COLLARD & ROE, P.C., 1077 NORTHERN BOULEVARD, ROSLYN, NY, 11576, US

(73) Assignee: Xella Technologie-und Forschungsgesellschaft mbH, Kloster Lehnin (DE)

(21) Appl. No.: 12/734,634

(22) PCT Filed: Jan. 13, 2009
(86) PCT No.: PCT/EP2009/050312

§ 371 Date: May 13, 2010

(30) Foreign Application Priority Data
Apr. 4, 2008 (DE) 10 2008 017 251.0

(51) Int. Cl. B28B 1/50; B28B 7/08

(52) U.S. Cl. 264/43; 425/4 R

(57) ABSTRACT

Process for the production of aerated-concrete or foamed-concrete moldings with envelope densities ≦450, where a cement- and sulfate-carrier-free lime formulation is produced, made of a CaO component made of a lime or lime hydrate and of an SiO₂ component, and of a blowing agent or foam, the constituents of the formulation are mixed with water to give a pourable composition, the composition is charged to a casting mold which has a base and side walls and end walls, and which has an inner space in the shape of a parallelepiped, the composition is allowed to undergo incipient hardening in the casting mold to give a concrete cake, and the casting mold is tipped through an angle of 90° onto one of its side walls, and the cake is removed from the shell, the cake is cut in a sawing unit to give moldings, a hardening base is placed on one of the long sides of the cut cake, and the hardening base together with cake and casting-mold side wall is tipped through an angle of 90° onto its long side, the side wall of the casting mold is removed, and the hardening base with concrete cake is transferred into an autoclave and autoclaved.

The invention relates to a method for the production of cellular concrete and foamed concrete having raw densities ≦450 kg/m³, and to a system for carrying out the method.

At present, cellular concrete of standardized quality classes (EN 771-4 and DIN V 4165-100) having raw densities ≦500 kg/m³ is produced, without exception, using so-called cement formulations. In this connection, a pourable mass composed of quicklime, in most cases fine lime, particularly white fine lime, cement, in most cases Portland cement, quartz meal or quartz sand or a corresponding SiO₂ component that is capable of reaction in a hydrothermal process, gypsum and/or anhydrite, aluminum powder or aluminum paste, and water is mixed and poured into a mold. In the mold, the mass foams up and solidifies to form a so-called cake. After solidification, the mass, which is present in the form of a large-format block having a length of 6 m, a width of 1.2 m, and a height of 0.7 m, for example, is cut into molded bodies, en bloc, and the cut molded bodies are introduced into an autoclave, en bloc, in which the mass is hydrothermally treated. In this connection, the molded body material hardens, forming calcium silicate hydrate phases, particularly in the form of tobermorite, to form cellular concrete. After completion of the autoclave treatment, the hardened molded bodies are removed from the autoclave, en bloc, and generally packaged.

This method on the basis of cement formulations with gypsum added has been developed after decades of development and optimization, proceeding from originally pure lime formulations that contained only quicklime as the CaO component that reacted in the hydrothermal process, as well as an SiO₂ component and an aluminum component, as well as water. This material was poured into flat molds having a height of about 30 cm, and autoclaved in the same. In this connection, the foaming height was also about 30 cm. In place of sand, flue ash and oil shale were predominantly used, both of which are pozzolanically active. However, in the transition to foaming heights of more than 50 cm, it has been shown that the quenching behavior of the lime could not be controlled, and the strength values and shrinkage behavior were insufficient, and for this reason, cement and later also gypsum and/or anhydrite were used in addition (for example AT-PS 17 77 13, DE 27 39 188 C2, DE-A-27 39 181).

Analogously, at present foamed concrete is also produced exclusively using cement.

With regard to the lime formulations, it is known that formulations with hard quicklime or hydraulic lime can be used and that solidified masses or cakes that are strong and can be cut can be produced, but that the strength values after autoclaving of the now hardened cellular concrete are relatively low and the structure, with regard to the pore distribution and the calcium silicate hydrate phase formation in a molded body, is non-homogeneous. Furthermore, only cellular concretes and foamed concretes having raw densities above 500 kg/m³ can be produced with sufficient strength values. For these reasons, the cement formulations that contain gypsum both as a component of the cement and in the form of a separate addition of gypsum or anhydrite had to be developed.

However, the cement formulations have serious disadvantages that must be accepted. Because of the gypsum added, lime grit formation can occur in the pourable mass, and the negative effects of this are known. Sometimes, so-called gray spots are also formed, which are indications of a non-uniform tobermorite formation in the block, so that the strength is impaired. The cement qualities frequently vary, so that formulation adjustments become necessary. In the production of cellular concrete, the so-called sediment sludge from in-house production is introduced into the formulation. The mineralogical composition of the sediment sludge is not constant, because calcium silicate hydrate phases have formed from the cement in different amounts. This has effects on the calcium silicate hydrate phase formation in the solidification and autoclaving process. Furthermore, the edge breaking resistance of the cellular concrete molded bodies made from cement formulations is sometimes deficient, because the cellular concrete material made from cement formulations is relatively brittle.

The most significant disadvantage of the cellular concrete and foamed concrete material, however, is that it contains sulfate from the cement and the added anhydrite/gypsum of the starting mixture. The sulfate can leach out. This makes the recycling of construction site waste and demolition material composed of cellular concrete more difficult, because the sulfate limit value for use in landscaping is not adhered to. Under some circumstances, during construction, sulfate ions can react with calcium silicate hydrate phases of the mineral mortar that is used, and form thaumasite (CaSiO₃×CaSO₄×CaCO₃×15H₂O). This thaumasite formation destroys the material composite by means of the crystallization that accompanies the increase in volume. The only effective counter-measure is testing and restricting the mortars and stuccos used with regard to their thaumasite formation.

It is the task of the invention to exclude thaumasite formation in cellular concrete and foamed concrete products of standardized quality classes, and preferably also to compensate the disadvantages of cement formulations.

This task is accomplished by means of a method having the characteristics of claims 1 and 14 and a system for the production of cellular concrete according to claim 12. Advantageous further developments of the invention are characterized in the dependent claims that depend on these claims.

What is disclosed in the following with regard to cellular concrete applies essentially also for foamed concrete.

The invention provides for the use of sulfate-free lime formulations for the production of cellular concrete. It is true that sulfate-free quicklime formulations as such are known. However, it has not yet been possible to produce cellular concrete having the properties of the quality classes that are currently required, with regard to raw density and strength values (EN 771-4 and DIN V 4165-100). Instead, the quality classes can only be guaranteed with cement formulations that must also contain gypsum, in order to achieve optimal tobermorite formation.

It is also known, in this connection, to supplement or replace the cement with hydraulic lime. In this connection, however, one assumes that in this case, as well, gypsum must be used in order to guarantee the quality characteristics (AT-PS 17 77 13).

Within the scope of the invention, it was recognized that in the case of lime formulations for the production of cellular concrete of the standardized quality classes, having raw densities ≦450, particularly 400 kg/m³, the important thing is not the solidified, cuttable consistency of the cake, which can easily be guaranteed with lime formulations, but rather the water content of the cake before it is placed into the autoclave. After a comprehensive investigation of the causes, it has been shown that the structure of the large-format cake from lime formulations is unstable, despite a relatively low weight, and that it changes disadvantageously in the autoclave during hydrothermal hardening, in that the water that is present in the cake seeps down from above and collects in the lower region of the cake. The upper region of the cake dries out and the mass of the lower region is enriched with water, and because of the load, it becomes so unstable that the cake can collapse. At least, however, the structure is changed so greatly that no molded bodies of the required quality classes, having a homogeneous structure, can be produced.

In order to solve this problem, the invention provides measures for immobilization of the water in the cake during the hydrothermal process.

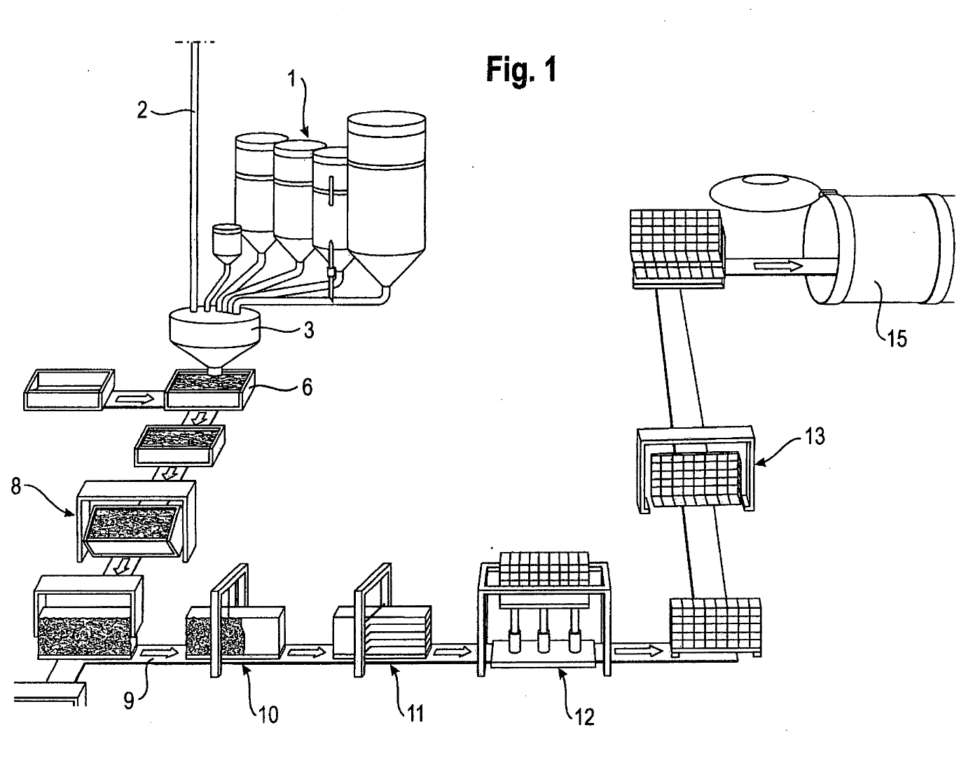

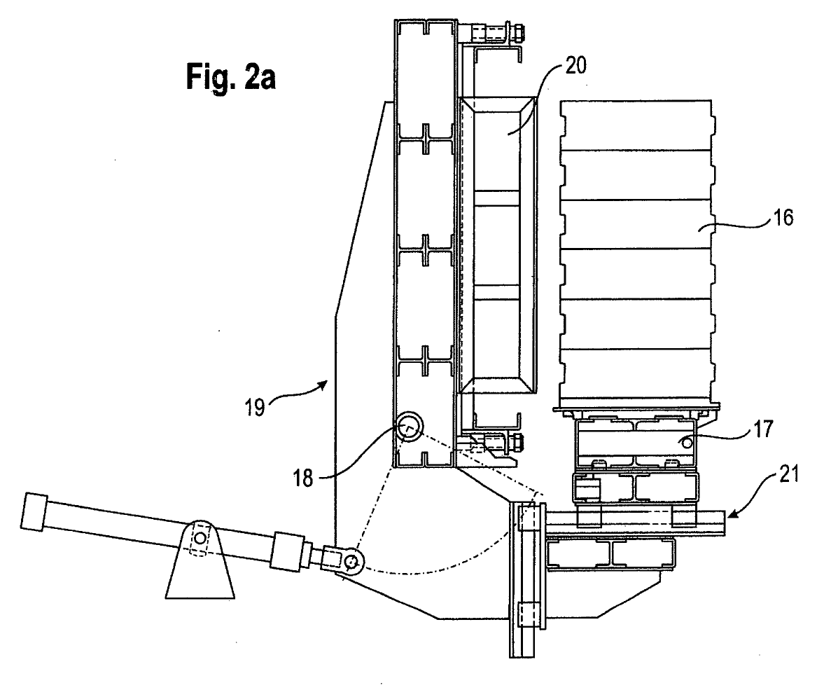

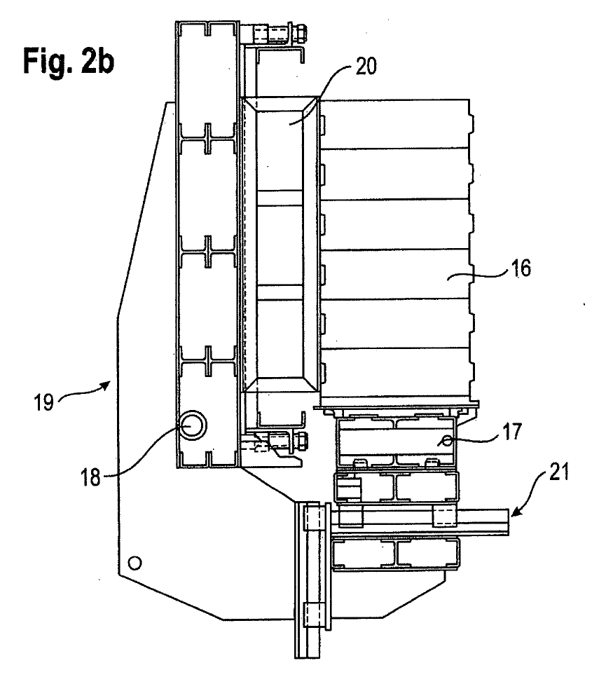

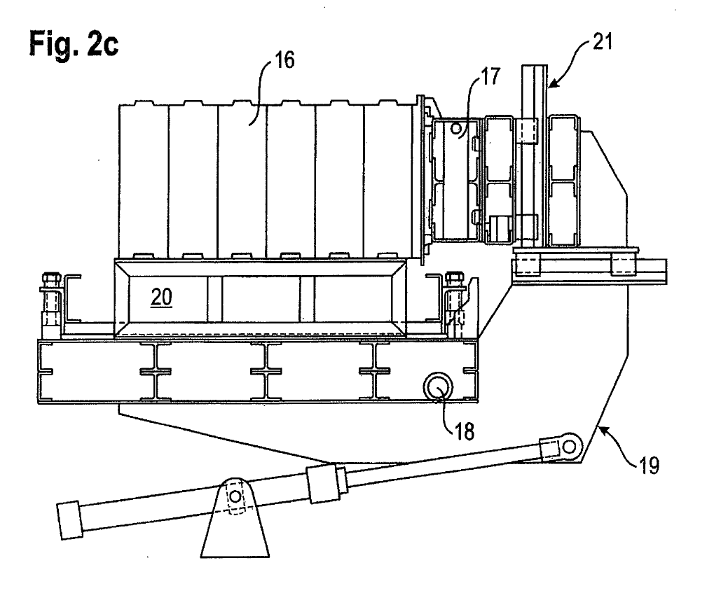

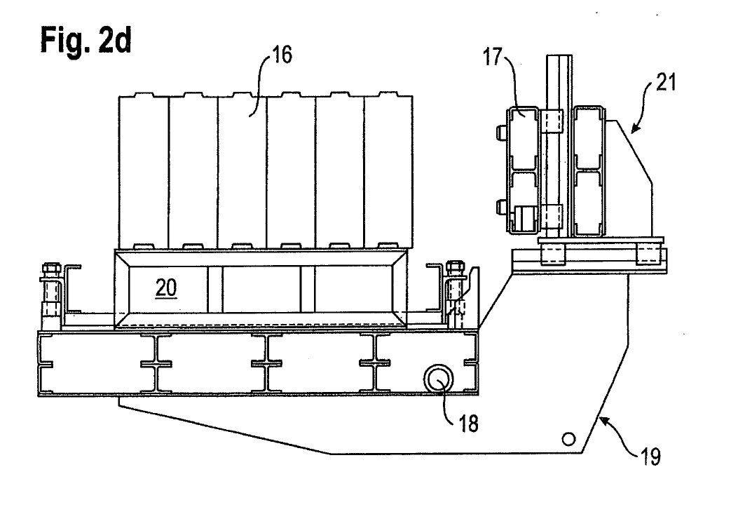

This is done, according to an embodiment of the invention, by means of mechanical method measures that will be described in the following, using FIGS. 1 and 2a to 2d. In this connection, the figures show:

FIG. 1 schematically, the method according to the invention for the production of cellular concrete, in a flow chart;

FIG. 2 the method steps of tipping the cake.

The components of a lime formulation are placed into a mixer 3, to which water is supplied by way of a water line 2, the components coming from supply containers 1 in which sulfate-free components for lime formulations for the production of cellular concrete are stored. The components are at least one CaO component that is capable of reaction in the hydrothermal process, such as quicklime or hydraulic lime, at least one SiO₂ component that is capable of reaction in the hydrothermal process, such as quartz meal or quartz sand, and aluminum powder or aluminum paste. Optionally, a filler component such as limestone meal, for example, which is inert during the autoclaving process, can also be added to the formulation.

Furthermore, the formulation can contain cellular concrete meal and/or raw material sediment sludge from production. In addition, admixtures such as flow agents, water retention agents and/or at least one additional, micro-particle SiO₂ additional component that reacts pozzolanically, for example, with the CaO component can have. The micro-particle other SiO₂ additional component already forms calcium silicate hydrate phases with the CaO component at an early point in time, without hydrothermal conditions and/or in the hydrothermal process, before the coarse SiO2 main component (quartz meal, quartz sand) reacts with the CaO component. Furthermore, because of its micro-particle nature, it binds free water adsorptively.

In particular, the following cement-free and gypsum-free lime formulations are used (information in wt.-%, with reference to the dry substance of the formulation):

in particular

| | | |
|---|---|---|
| CaO component | 10-40 | 15-30 |
| SiO₂ component | 40-70 | 55-65 |
| Inert filler | 0-30 | 0-20 |
| Cellular concrete | 0-30 | 5-15 |
| meal/gravel | | |
| Raw material | 0-30 | 15-25 |
| sediment sludge | | |
| Aluminum component | 0.8-3 | 1.0-1.8 |
| Micro-particle SiO₂ | 0-8 | 0-3 |
| additional component | | |
| Flow agents | 0-2.5 | 0-1 |
| Water retention | 0-3 | 0-1 |
| agents | | |

In this connection, the CaO/SiO₂ mole ratio of the components capable of reaction in the hydrothermal process is adjusted to be between 0.15 and 0.95, particularly between 0.30 and 0.40, and a mass capable of flow, having a water/solid ratio between 0.45 and 1.35, particularly between 0.48 and 0.63, is produced. The flowability can be adjusted by means of the corresponding addition of flow agents and/or water retention agents, with a corresponding change in the water content.

The invention provides for using pure lime formulations and physically preventing collapse. Furthermore or instead, the free water content in the solidified mass is reduced and/or immobilized by means of the use of at least one flow agent and/or one water retention agent and/or one adsorption agent for water, such as cellular concrete meal or gravel and/or a micro-particle additive that binds water adsorptively and chemically, and increases the strength, such as micro-particle SiO₂, and/or vibration of the mass during pouring and/or foaming at a lower water content, which leaves the structure of the cake during the autoclaving process unimpaired, due to the load.

In particular, white fine lime in the form of soft quicklime or hard quicklime with CaO contents above 88, particularly between 92 and 96 wt.-% is used as the CaO component. Furthermore, sulfate-free hydraulic lime can be used as the single CaO component or in combination with white fine lime, whereby the hydraulic lime should have CaO contents between 50 and 90, particularly between 65 and 85 wt.-%. Likewise, the use of lime hydrate instead of quicklime or a combination of quicklime and lime hydrate lies within the scope of the invention.

The relatively coarse Si0₂ main component is primarily ground quartz sand or quartz meal of the usual fineness, having a normal Gauss grain distribution up to grain sizes of 0.13, particularly up to 0.10 mm. The SiO₂ content preferably amounts to more than 80, particularly more than 85 wt.-%.

Aside from ground quartz sand or quartz meal, flue ash can also be used as the SiO₂ main component. The ground SiO₂ component is preferably present as dry meal (<0.1 mm), because in this way, the technological influence on the casting temperature can be better controlled by means of the temperature of the so-called free casting water passed to the mixer than when using sand slurry. Nevertheless, the use of sand slurry lies within the scope of the invention, as does the use of composite meal. Composite meal generally consists of sand and the lime component, ground together.

Sulfate-free cellular concrete material in the form of cellular concrete meal and/or cellular concrete gravel is used at fineness values up to 1.5 mm, particularly up to 1.0 mm, for example. The sulfate-free cellular concrete raw material sediment sludge comes from production and is circulated. Sediment sludge is sawing waste mixed with water, for example, and can be pumped.

A synthetic silica (Winnacker-Kuchler, Chemische Technologie [Chemical Technology], Volume 3, Anorganische Technologie [Inorganic Technology] II, 4^{th} edition, Carl Hauser Verlag Munich, Vienna, 1983, p. 75-90) is used as the micro-particle, i.e. highly dispersed silica. In particular, pyrogenic silicas that are produced by way of flame hydrolysis, as well as precipitation silicas, are used. Precipitation silicas can be used in unground or steam-jet-ground or spray-dried or spray-dried and ground form. Such precipitation silicas are commercially available under the name “DUROSIL” and “SIPERNAT,” for example. The synthetic silicas from flame hydrolysis are on the market under the name “AEROSIL.” The specific surface of these synthetic silicas should amount to more than 10 m²/g according to BET and between 20 and 50 m²/g, for example. When highly dispersed silicas with higher surfaces, for example 100-500 m²/g, are used, the amount required for use is reduced.

The aluminum component is introduced either as aluminum powder or aluminum paste.

Liquefiers from the concrete industry, on the basis of melamine sulfonates, naphthalene sulfonates, polycarboxylate ethers, or lignin sulfonates, for example, can be used as flow agents. These are described in the Internet, for example, under “Admixture News. No. 1-January 2008, BASF Construction Chemicals Europe AG.”

Effective water retention agents are starch or cellulose ether, for example.

The mixture components are mixed in the mixer 3, as usual, to form a pourable mass, and the pourable mass is filled into a large-volume casting mold 6 made of metal, having a block-shaped interior, and open at the top. The dimensions of the interior amount to, for example: length 6.0 m, width 1.2 m, height 0.7 m.

The casting mold 6 has a mold bottom and two side walls that surround the mold bottom, as well as two face walls that surround the mold bottom. The side walls and face walls can be removed from the mold bottom. In the casting mold 6, the mass foams up and hardens to form a self-supporting, cut-stable, green cellular concrete cake. After solidification, the casting mold 6 is tipped onto one of the side walls in a first tipping device 8, and thus set long side up, so that the cake, standing on one of its narrow sides, on the side wall, is also set long side up. The other side wall as well as the bottom and the face walls of the casting mold 6 are removed. The cake, standing long side up on the side wall of the casting mold, is conveyed into a transport line 9 by the tipping device 8 and brought into a first cutting station 10 with a face side in front; there, the bottom layer and the top layer of the cake are cut off, with vertical cutting wires, from front to back. Afterwards, the cake is conveyed into a second cutting station 11 having cutting wires stretched horizontally, crosswise to the longitudinal expanse of the cake, in which station horizontal cuts from front to back are carried out. Subsequent to this, the cake gets into a third cutting station 12 (transverse saw), which has at least one cutting wire stretched preferably horizontally, extending crosswise at a 90° angle to the longitudinal direction of the cake, in which the cake is cut from top to bottom.

It is essential to the invention that the cake is passed to a second tipping device 13 after the cutting processes, in a long-side-up position, in which device the cake, which is standing long side up, is combined with a hardening rack and subsequently tipped onto its broad side, together with the hardening rack. In this position, the cake, together with the hardening rack, is then moved into an autoclave 15, in which hydrothermal hardening takes place, as usual.

Because the cake is tipped back onto its broad side, the result is surprisingly achieved that in the case of pure lime formulations, even without admixtures and without additives and without vibration, the load of the cake remains so slight that enough water remains immobilized in the cake so that the structure of the cake that corresponds to the production of a cellular concrete having raw densities ≦400 kg/m³ and having the required quality classes is maintained. Because of the relatively slight load in comparison with the load of a cake standing long side up, the water does not seep down in such amounts that the cake collapses. Instead, sulfate-free molded blocks composed of cellular concrete, having raw densities ≦400 kg/m³ and having the required quality class properties, can be produced, corresponding to cellular concretes produced from cement formulations.

Without admixtures and without additives, and without vibrating, cake heights up to 0.75, particularly up to 0.70 m, can easily be autoclaved, without damage. If higher cakes are supposed to be autoclaved, vibration can be performed when pouring the mass that has less water than needed for the required pourability, and/or a flow agent can be added to the formulation, and/or in particular if the pourable mass is supposed to have normal amounts of water for pouring, water retention agents and/or highly dispersed silicas can be added, thereby immobilizing the water in the cake accordingly. With these additional means and/or measures, it is possible to autoclave a cake from a lime formulation even long side up, so that the second tipping device can be eliminated. This is particularly true for lime formulations that only has one reactive, highly pure, highly dispersed silica, for example micro-silica in amounts from 3 to 15, particularly from 5 to 8 wt.-%, with reference to the CaOH₂ content of the lime. The SiO₂ content of the silica should not lie below 92 wt.-%, in this connection. The highly dispersed silica is particularly used at specific BET surfaces between 20 and 50 m2/g. Due to a large specific surface, water is adsorptively bound, and calcium silicate hydrate phases are formed with the lime component, specifically already in the green state of the cake, so that the water is immobilized for the autoclave process and collapse of the cake in the autoclave can be avoided.

From EP 1 892 226 A2, it is known to add a micro-porous or nano-porous silica in the form of micro-porous or nano-porous particles to a cellular concrete mixture. This type of silica, which is micro-porous or nano-porous, survives the autoclave process without harm, and the particles remain in the basic matrix in which they are bound. The present invention cannot be implemented with such a micro-porous or nano-porous silica, because it is important that the highly dispersed silica reacts pozzolanically and forms calcium silicate hydrate phases.

For better capacity utilization of the autoclave, multiple cakes stacked one above the other, lying on hardening racks, can be hardened in an autoclave at the same time, if the hardening racks are separately supported in the autoclave, in each instance, and do not sit on the cake that is situated underneath them.

Autoclaving of cakes that lie on their broad side on hardening racks is known from DE-A-21 08 300 or DE-A-23 07 031, for example. In these known methods, the cake is first completely unmolded, for cutting, and passed to the cutting device with lifting devices or suction devices. Because of their unstable structure and consistency, cakes made from lime formulations do not survive this transport. Only the combination of a cutting method according to DE 958.639 B with a tipping method onto a broad side of the cake, corresponding to the two Offenlegungsschrift documents [unexamined patent published for public scrutiny] indicated above, after cutting, allows production of cellular concrete from lime formulations. In this regard, the second tipping process represents an additional measure that is not obvious in this connection, because in the state of the art, tipping back took place in order to prevent molded bodies that were disposed one on top of the other from caking together during'autoclaving, or in order to remove the bottom layer.

The solution of the task set according to the invention by means of admixtures and/or additives and/or vibration, while maintaining autoclaving of cakes set long side up, according to the second embodiment of the invention, also cannot be derived from the state of the art, because the problems that occur in the case of cakes on the basis of lime formulations in the autoclave process were unknown.

FIG. 2a shows the positioning of a cut cake standing long side up on a mold side wall, which cake has come from a cutting system, not shown. The side wall 17 sits on a transport device 21. The cake 16 is positioned in front of a hardening rack 20 that is held by a tipping table 19 that can be tipped about a horizontal axis 18.

According to FIG. 2b, the cake 16 is pushed up to the hardening rack 20 with the side wall 17 and the transport device 21.

The cake 16, together with side wall 17 and transport device 21, is tipped about the axis 18, by 90°, using the tipping table 19, and then lies on the hardening rack 20 with its broad side (FIG. 2c).

Afterward, the side wall 17 and the transport device 21 are moved away from the cake, to the side (FIG. 2d).

Subsequently, the hardening rack 20, with the cake 16, is conveyed to an autoclave 15, the tipping table 19 with the side wall 17 and the transport device 21 is tipped back, and the transport device 21 with the side wall 17 is conveyed out of the tipping system (not shown).

1. Method for hydrothermal production of cellular concrete molded bodies or foamed concrete molded bodies of standardized quality classes, having raw densities ≦450, particularly 400 kg/m³, comprising the combination of the following characteristics:
A lime formulation that is cement-free and sulfate-carrier-free, and, in particular, also sulfate-free, composed of at least one CaO component that is capable of reaction in a hydrothermal process, composed of quicklime, particularly white fine lime and/or hydraulic lime or their hydrates, and at least one SiO₂ component that is capable of reaction in a hydrothermal process, particularly in the form of ground quartz sand having grain sizes up to 0.13 mm, as well as a propellant, in the form of aluminum powder or aluminum paste, or pre-finished foam, is produced, whereby the composition of the formulation is selected in such a manner that raw densities of autoclaved cellular concrete or foamed concrete bodies ≦450 can be guaranteed,
the formulation components are placed into a mixer and mixed with water to produce a pourable mass, whereby in the case of the addition of quicklime the lime quenches to form lime hydrate,
the water-containing mass is filled into a large-volume, rectangular casting mold that has a bottom and removable side and face walls, as well as a block-shaped interior,
in the casting mold, the mass is brought to pore-forming foaming and solidification in the production of cellular concrete, or to solidification in the production of foamed concrete, to form a green, self-supporting and cut-stable concrete cake,
the casting mold is tipped by 90°, onto one of its side walls, and the cake is unmolded by removing the bottom, the face walls, and the other side wall,
the cake, standing long side up on one of its narrow sides, is cut in a sawing station, to produce at least one molded body by means of horizontal and vertical cuts,
a hardening bottom, particularly a hardening rack, that stands long side up is set onto one broad side of the cut cake, and the hardening bottom, together with cake and casting mold side wall, is tipped by 90°, onto its broad side, by a tipping device, so that the cake comes to lie on the hardening bottom with its broad side,
the casting mold side wall is removed, and the hardening bottom with the cut concrete cake is placed into an autoclave and the concrete cake is autoclaved in it,
after autoclaving, the hydrothermally hardened concrete material is removed from the autoclave.

2. Method according to claim 1, wherein a formulation for cellular concrete is selected from the following component amounts in wt.-%, with reference to the dry solid portion:
in particular

| | | |
|---|---|---|
| CaO component | 10-40 | 15-30 |
| SiO₂ component | 40-70 | 55-65 |
| Inert filler | 0-30 | 0-20 |
| Cellular concrete | 0-30 | 5-15 |
| meal/gravel | | |
| Raw material | 0-30 | 15-25 |
| sediment sludge | | |
| Aluminum component | 0.8-3 | 1.0-1.8 |
| Micro-particle SiO₂ | 0-8 | 0-3 |
| additional | | |
| component | | |
| Flow agents | 0-2.5 | 0-1 |
| Water retention | 0-3 | 0-1 |
| agents | | |

3. Method according to claim 2, wherein
a water/solid ratio for the pourable mass is adjusted, between 0.45 and 1.35, particularly between 0.48 and 0.63.

4. Method according to claim 1, wherein
a CaO/SiO₂ mole ratio of the components that react in the hydrothermal process is adjusted, between 0.15 and 0.95, particularly between 0.30 and 0.40.

5. Method according to claim 2, wherein
melamine sulfonates and/or lignin sulfonates and/or naphthalene sulfonates and/or polycarboxylate ethers are used as a flow agent.

6. Method according to claim 2, wherein
starch or cellulose ether is used as a water retention agent.

7. Method according to claim 2, wherein
a synthetic silica is used as a micro-particle SiO₂ additional component.

8. Method according to claim 7, wherein
a pyrogenic silica and/or a precipitation silica is used as a synthetic silica.

9. Method according to claim 7, wherein
the synthetic silica is used with BET surfaces above 10, particularly between 20 and 50 m²/g.

10. Method according to claim 1, wherein
the pourable mass is vibrated when it is poured and/or in the casting mold.

11. Method according to claim 1, wherein
the cut cake is produced at a height of 0.4 to 0.8 m, particularly of 0.5 to 0.7 m.

12. System for the production of cellular or foamed concrete molded bodies according to a method according to claim 1, further comprising the process-technology coupling of at least the following devices:
supply container 1, a mixer 3, a water line 2 leading to the mixer 3, a casting station with casting molds 6 having removable side walls and face walls, a first tipping device 8 set up for tipping a casting mold 6 that contains a solidified cake onto a narrow side wall of the casting mold, a cutting line 9 having cutting stations 10, 11, 12, for cutting a cake that stands long side up, a hardening rack feed device, a second tipping device 13 set up for tipping a cut cake together with mold side wall and hardening rack by 90° onto its broad side, an autoclave, as well as transport means between the devices and, for the production of foamed concrete, a foam generator with foam feed lines to the mixer (3).

13. System according to claim 12, further comprising a vibration device for vibrating the pourable mass during pouring and/or after pouring.

14. Method for hydrothermal production of cellular or foamed concrete molded bodies of standardized quality classes, having raw densities ≦450, particularly 400 kg/m³,
comprising the combination of the following characteristics:
A lime formulation that is cement-free and sulfate-carrier-free, and, in particular, also sulfate-free, composed of at least one CaO component that is capable of reaction in a hydrothermal process, composed of quicklime, particularly white fine lime and/or hydraulic lime or their hydrates, and at least one SiO₂ component that is capable of reaction in a hydrothermal process, particularly in the form of ground quartz sand having grain sizes up to 0.13 mm, as well as a propellant, in the form of aluminum powder or aluminum paste for the production of cellular concrete or a pre-finished foam for the production of foamed concrete, and a highly dispersed synthetic silica is produced,
the formulation components are placed into a mixer and mixed with water to produce a pourable mass, whereby the lime quenches to form lime hydrate,
the water-containing mass is filled into a large-volume, rectangular casting mold that has a bottom and removable side and face walls, as well as a block-shaped interior,
in the casting mold, the mass is brought to pore-forming foaming and solidification in the production of cellular concrete, or to solidification in the production of foamed concrete, to form a green, self-supporting and cut-stable concrete cake,
the casting mold is tipped by 90°, onto one of its side walls, and the cake is unmolded by removing the bottom, the face walls, and the other side wall,
the cake, standing long side up on one of its narrow sides, on the side wall of the casting mold, is cut in a cutting station, to produce at least one molded body by means of horizontal and vertical cuts,
the cut cake is placed into an autoclave, standing long side up on the side wall of the casting mold, and autoclaved there,
after autoclaving, the hydrothermally hardened concrete material is removed from the autoclave.

15. Method according to claim 14, wherein
a formulation for the production of cellular concrete is selected from the following component amounts in wt.-%, with reference to the dry solid portion:
in particular

| | | |
|---|---|---|
| CaO component | 10-40 | 15-30 |
| SiO₂ component | 40-70 | 55-65 |
| Inert filler | 0-30 | 0-20 |
| Cellular concrete | 0-30 | 5-15 |
| meal/gravel | | |
| Raw material | 0-30 | 15-25 |
| sediment sludge | | |
| Aluminum component | 0.8-3 | 1.0-1.8 |
| Micro-particle SiO₂ | [0-8] | [0-3] |
| additional | 1-8 | 1-3 |
| component | | |
| Flow agents | 0-2.5 | 0-1 |
| Water retention | 0-3 | 0-1 |
| agents | | |

16. Method according to claim 14, wherein a water/solid ratio for the pourable mass is adjusted, between 0.45 and 1.35, particularly between 0.48 and 0.63.

17. Method according to claim 14, wherein
a CaO/SiO₂ mole ratio of the components that react in the hydrothermal process is adjusted, between 0.15 and 0.95, particularly between 0.30 and 0.40.

18. Method according to claim 15, wherein
melamine sulfonates and/or lignin sulfonates and/or naphthalene sulfonates and/or polycarboxylate ethers are used as flow agents.

19. Method according to claim 15, wherein
starch or cellulose ether is used as a water retention agent.

20. Method according to claim 15, wherein
a synthetic silica is used as a highly dispersed SiO₂ additional component.

21. Method according to claim 20, wherein
a pyrogenic silica and/or a precipitation silica is used as a synthetic silica.

22. Method according to claim 20, wherein
the synthetic silica is used with BET surfaces above 10, particularly between 10 and 500, preferably between 20 and 50 m²/g.

23. Method according to claim 14, wherein
the pourable mass is vibrated when it is poured and/or in the casting mold.

24. Method according to claim 14, wherein
the cut cake is produced at a height of 1 to 1.5 m, particularly of 1.1 to 1.25 m.

25. Method according to claim 14, wherein
a system for the production of cellular or foamed concrete molded bodies is used, which comprises the process-technology coupling of at least the following devices:
supply container 1, a mixer 3, a water line 2 leading to the mixer 3, a casting station with casting molds 6 having removable side walls and face walls, a first tipping device 8 set up for tipping a casting mold 6 that contains a solidified cake onto a narrow side wall of the casting mold, a cutting line 9 having cutting stations 10, 11, 12, for cutting a cake that stands long side up, an autoclave, as well as transport means between the devices and, for the production of foamed concrete, a foam generator with foam feed lines to the mixer (3).

26. Method according to claim 25, wherein
a system is used that has a vibration device for vibrating the pourable mass during pouring and/or after pouring.
